(19) United States
(12) Patent Application Publication
(10) Pub. No.: US 2025/0229801 A1
(43) Pub. Date: Jul. 17, 2025

(54) TRAJECTORY PLANNING METHOD, ELECTRONIC DEVICE AND STORAGE MEDIUM

(71) Applicant: Apollo Intelligent Connectivity (Beijing) Technology Co., Ltd, Beijing (CN)

(72) Inventors: Fan Zhu, Beijing (CN); Meng WANG, Beijing (CN)

(21) Appl. No.: 18/964,205

(22) Filed: Nov. 29, 2024

(30) Foreign Application Priority Data
Jan. 17, 2024 (CN) 202410069687.8

(51) Int. Cl. B60W 60/00; G01C 21/32

(52) U.S. Cl. CPC B60W 60/001; G01C 21/32; B60W 2556/40

(57) ABSTRACT

Provided is a trajectory planning method, an electronic device and a storage medium, relating to the fields of trajectory planning and map data processing. The trajectory planning method includes: planning a target standard definition (SD) trajectory in an SD map based on a start point and an end point of a trajectory; matching respective high definition (HD) trajectory segments in an HD map based on individual SD trajectory segments in the target SD trajectory; connecting nodes corresponding to individual HID lanes in the individual HID trajectory segments based on relations between the individual HID lanes in the individual HD trajectory segments to obtain a topology map; determining a target route in the topology map based on the start point and the end point of the trajectory; and determining a corresponding target HD trajectory in the HD map based on the target route.

### CROSS-REFERENCE TO RELATED APPLICATIONS

The present application claims priority to Chinese Patent Application No. CN202410069687.8, filed with the China National Intellectual Property Administration on Jan. 17, 2024, the disclosure of which is hereby incorporated herein by reference in its entirety.

### TECHNICAL FIELD

The present disclosure relates to the field of artificial intelligence technology, especially to the fields of trajectory planning and map data processing, which is applied to scenarios such as autonomous driving and intelligent transportation. Particularly, the present disclosure relates to a trajectory planning method and apparatus, an electronic device and a storage medium.

### BACKGROUND

Path or trajectory planning is performed in a standard definition (SD) map to output a path or trajectory planning result, and then path or trajectory matching is performed in a high definition (HD) map to output a lane-level path or trajectory for autonomous driving navigation.

Therefore, the path matching is one of technical keys in utilizing the SD map and the HD map for the autonomous driving navigation.

### SUMMARY

The present disclosure provides a trajectory planning method and apparatus, an electronic device and a storage medium.

According to one aspect of the present disclosure, provided is a trajectory planning method, including:
planning a target SD trajectory in an SD map based on a start point and an end point of a trajectory;
matching respective HD trajectory segments in an HD map based on individual SD trajectory segments in the target SD trajectory;
connecting nodes corresponding to individual HD lanes in the individual HD trajectory segments based on relations between the individual HD lanes in the individual HD trajectory segments to obtain a topology map;
determining a target route in the topology map based on the start point and the end point of the trajectory; and
determining a corresponding target HD trajectory in the HD map based on the target route.

According to another aspect of the present disclosure, provided is a trajectory planning apparatus, including:
a trajectory planning module configured to plan a target SD trajectory in an SD map based on a start point and an end point of a trajectory,
a trajectory segment matching module configured to match respective HD trajectory segments in an HD map based on individual SD trajectory segments in the target SD trajectory,
a topology map constructing module configured to connect nodes corresponding to individual HD lanes in the individual HD trajectory segments based on relations between the individual HD lanes in the individual HD trajectory segments to obtain a topology map,
a target route determining module configured to determine a target route in the topology map based on the start point and the end point of the trajectory, and
a target trajectory determining module configured to determine a corresponding target HD trajectory in the HD map based on the target route.

According to another aspect of the present disclosure, provided is an electronic device, including:
at least one processor, and
a memory connected in communication with the at least one processor,
wherein the memory stores an instruction executable by the at least one processor, and the instruction, when executed by the at least one processor, enables the at least one processor to perform the trajectory planning method of any one of embodiments of the present disclosure.

According to another aspect of the present disclosure, provided is a non-transitory computer-readable storage medium, storing a computer instruction thereon, wherein the computer instruction is used to cause a computer to perform the trajectory planning method of any one of embodiments of the present disclosure.

According to another aspect of the present disclosure, provided is a computer program product, including a computer program that, when executed by a processor, implements the trajectory planning method of any one of embodiments of the present disclosure.

According to the technology of the present disclosure, the lane topology map is constructed by utilizing the individual lanes in the individual HD trajectory segments matching with the individual SD trajectory segments in the target SD trajectory, and then the target route matching with the SD trajectory is searched in the lane topology map. As such, the target route matching with the SD trajectory can be searched by utilizing the relations between the lanes. Furthermore, the corresponding target HD trajectory is determined by means of the target route in the HD map, and the HD trajectory well matching with the SD trajectory can be obtained. Therefore, the matching effect of the SD trajectory with the HD trajectory can be improved by employing the technology of the present disclosure.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

Accompanying drawings are intended for a better understanding of the solution and do not constitute a limitation of the present disclosure.

FIG. 1 is a schematic diagram of an autonomous driving scenario according to the present disclosure.

FIG. 2 is a flowchart of a trajectory planning method according to an embodiment of the present embodiment.

FIG. 3 is a topology map according to an embodiment of the present disclosure.

FIG. 4 is a schematic diagram of node groups and a target route according to an embodiment of the present embodiment.

FIG. 5 is a block diagram showing a structure of a trajectory planning apparatus according to an embodiment of the present embodiment.

FIG. 6 is a block diagram showing a structure of a trajectory planning apparatus according to an embodiment of the present embodiment.

FIG. 7 is a block diagram showing an electronic device according to an embodiment of the present disclosure.

### DETAILED DESCRIPTION

Exemplary embodiments of the present disclosure will be described hereinafter in conjunction with accompanying drawings, which include various details of the embodiments of the present disclosure to aid in understanding and which should be considered merely exemplary. Accordingly, those ordinarily skilled in the art should recognize that various changes and modifications can be made to the embodiments described herein without departing from the scope of the present disclosure. Similarly, descriptions of well-known features and structures will be omitted from the following description for the sake of clarity and brevity.

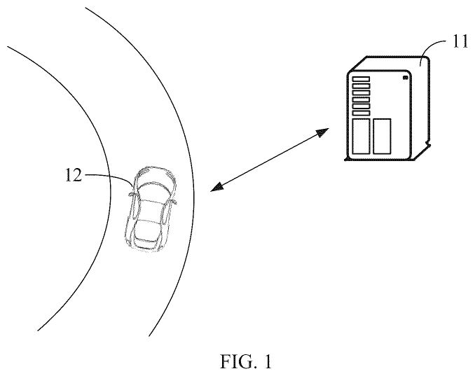

FIG. 1 is a schematic diagram of an autonomous driving scenario according to the present disclosure. As shown in FIG. 1, when an autonomous vehicle 12 performs navigation by using an autonomous driving system including a navigation system (compared to an autonomous driving system without a navigation system), there is a necessary step to match an SD trajectory with an HD trajectory. The SD trajectory is planned based on an SD map, for example, a map on a mobile phone or an on-board unit. An HD route is planned based on the HD map. The HD map is often stored in a server 11 and needs to requested from the server.

The autonomous driving system has a navigation process described as follows.
1. A user enters a destination and uses an optimal route found by using the SD map as the SD trajectory.
2. A matching system finds an HD route matching with the SD trajectory by means of a matching table.
3. The autonomous driving system queries a corresponding HD trajectory in the HD map by using the HD route and uses it for autonomous driving navigation.

The SD map includes information such as a plurality of roads, trajectory points on individual roads and directions of roads. The HD map includes information such as a plurality of roads, trajectory points on individual lanes in individual roads, directions of individual roads, and directions of individual lanes. Therefore, main road lanes and side road lanes on the same road are not distinguished in the SD map and are considered as the same trajectory segment. However, the main road lanes and the side road lanes are distinguished in the HD map and are considered as two different trajectory segments.

Furthermore, in the second step, when the SD trajectory includes the main road lanes and the side road lanes, when the HD route is matched, two different HD routes are matched. In this way, it is uncertain that which HD route is the HD route matching with the SD trajectory (the target route of the embodiment of the present disclosure). Furthermore, it is impossible to accurately determine the HD trajectory.

Therefore, the process is improved according to the embodiment of the present disclosure, such that the above-mentioned situation is avoided. Moreover, a more accurate HD route is matched, such that an accurate HD trajectory is obtained.

The embodiment of the present disclosure is applied in the autonomous driving scenario, which is only an example. The embodiment of the present disclosure may be applied to other transportation scenarios such as a parking scenario, and is not detailed herein.

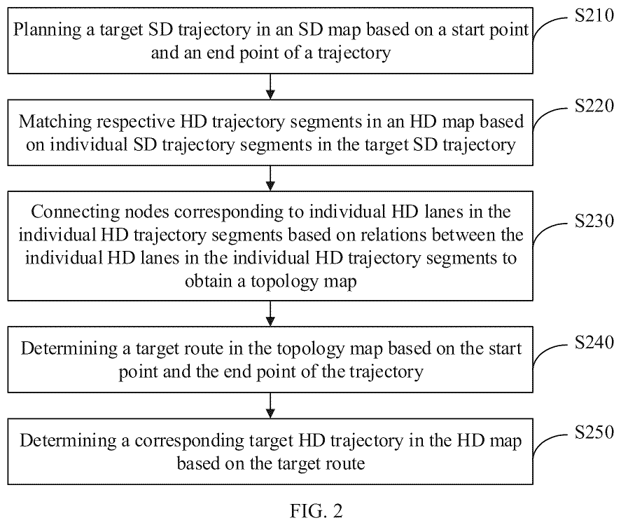

FIG. 2 is a flowchart of a trajectory planning method according to an embodiment of the present disclosure. The method can be applied to an electronic device. For example, the electronic device is a terminal, a server or other processing device, wherein the terminal can be a desktop computer, a mobile device, a PDA (Personal Digital Assistant), a handheld device, a computing device, a vehicle-mounted device, a wearable device, and other user equipment (UE). In some embodiments, the electronic device may implement the trajectory planning method of the embodiment of the present disclosure in a manner of invoking a computer-readable instruction stored in a memory by a processor.

As shown in FIG. 2, the trajectory planning method can include:
S210, planning a target SD trajectory in an SD map based on a start point and an end point of a trajectory;
S220, matching respective HD trajectory segments in an HD map based on individual SD trajectory segments in the target SD trajectory;
S230, connecting nodes corresponding to individual HD lanes in the individual HD trajectory segments based on relations between the individual HD lanes in the individual HD trajectory segments to obtain a topology map;
S240, determining a target route in the topology map based on the start point and the end point of the trajectory; and
S250, determining a corresponding target HD trajectory in the HD map based on the target route.

It should be understood that the start point of the trajectory is a current driving position of a vehicle, or can be a start point position determined at random. The end point of the trajectory is a driving destination of the vehicle, or can be an end point location determined at random.

It should be understood that the SD trajectory is a trajectory planned in the SD map and communicated from the start point of the trajectory to the end point of the trajectory. The SD trajectory includes a plurality of trajectory points in a road. Segmenting the SD trajectory can result in a plurality of SD trajectory segments. Each of the SD trajectory segment consists of individual trajectory points on one or more contiguous roads.

It should be understood that each of the HD trajectory segments can include one or more contiguous lanes and individual trajectory points on the individual lanes.

It should be understood that the number of the HD trajectory segments matching with the SD trajectory segments can be one or more.

It should be understood that the HD trajectory segments matching with the SD trajectory are matched according to a distance, a communication relation and the like.

It should be understood that HD lanes are extracted from the individual HD trajectory segments to obtain an HD lane set, and the lanes in the HD lane set are deduplicated. For the individual lanes in the HD lane set after the deduplication is performed, the relations between the two lanes can include an anterior-posterior connection relation, a parallel relation, a non-anterior-posterior connection relation, a non-parallel relation, and the like.

It should be understood that an HD lane is one node in the topology map, and edges are constructed for nodes corresponding to the two HD lanes by using relations between any two HD lanes, such that the topology map can be obtained. Since the nodes in the topology map represent the HD lanes, the topology map can be referred to as a lane topology map.

It should be understood that the topology map includes a plurality of nodes, as well as a connection relation and a communication relation of the individual nodes. For example, two adjacent nodes are unidirectionally or bidirectionally connected, or are not connected, and the first node and the second node separated by one or more intermediate nodes are unidirectionally communicated or bidirectionally connected.

It should be understood that the corresponding first node is determined based on the HD lane where the start point of the trajectory is located, the corresponding second node is determined based on the HD lane where the end point of the trajectory is located, at least one alternative route communicated from the first node to the second node is determined in the topology map, and the target route is determined based on the at least one alternative route. A desirable route can be selected as the target route from a plurality of alternative routes, or the target route can be obtained by splitting and reorganizing the plurality of alternative routes.

It should be understood that each of the alternate routes includes a plurality of contiguous nodes communicated from the first node to the second node and connection relations between the individual nodes, wherein each of the nodes represents one HD lane.

It should be understood that the target route includes a plurality of contiguous nodes communicated from the first node to the second node and connection relations between the nodes, wherein each of the nodes represents one HD lane. Alternatively, the target route includes a plurality of contiguous node groups communicated from the first node to the second node, wherein each of the node groups includes one or more nodes bidirectionally communicated, and each of the nodes represents one HD lane.

It should be understood that the respective lanes are searched in the HD map based on the individual nodes in the target route, such that the target HD trajectory is determined.

It should be understood that the target HD trajectory can include the trajectory points on the one or more lanes.

According to the implementation, a lane topology map is constructed by utilizing the individual lanes in the individual HD trajectory segments matching with the individual SD trajectory segments in the target SD trajectory, and then the target route matching with the SD trajectory is searched in the lane topology map. As such, the target route matching with the SD trajectory can be searched by utilizing the relation between the lanes. Furthermore, the corresponding target HD trajectory is determined by means of the target route in the HD map, and the HD trajectory well matching with the SD trajectory can be obtained. Therefore, the matching effect of the SD trajectory with the HD trajectory can be improved by employing the technology of the present disclosure.

A process for constructing the topology map will be exemplarily introduced below.

In one implementation, the connecting nodes corresponding to individual HD lanes in the individual HD trajectory segments based on relations between the individual HD lanes in the individual HD trajectory segments to obtain a topology map includes: determining an HD lane set based on the individual HD lanes in the individual HD trajectory segments; and unidirectionally connecting individual nodes corresponding to the individual lanes in the HD lane set based on an anterior-posterior connection relation between the individual HD lanes in the HD lane set to obtain the topology map.

It should be understood that the HD lanes are extracted from the individual HD trajectory segments to obtain a plurality of HD lanes, and the plurality of HD lanes are deduplicated to obtain the HD lane set.

It should be understood that for any two HD lanes in the HD lanes that have the anterior-posterior connection relation, the nodes corresponding to the two HD lanes are connected unidirectionally in a direction from a node corresponding to the HD lane in the front to a node corresponding to the HD lane in the back. As such, the above operation is performed on all two HD lanes in the HD lanes that have the anterior-posterior connection relation, such that the topology map is obtained.

According to the implementation, the HD lane set is constructed by utilizing the individual HD lanes in the individual HD trajectory segments, and then the individual nodes corresponding to the individual HD lanes in the HD lane set are connected unidirectionally by utilizing the anterior-posterior connection relation of the individual HD lanes in the HD lane set, such that the topology map of the nodes with directed edges can be obtained. Thus, it is convenient to search in the topology map for a route communicated from a start point node to an end point node in the future.

In one implementation, the method may further include: if a first HD lane and a second HD lane in the HD lane set are parallel lanes, bidirectionally connecting a node corresponding to the first HD lane and a node corresponding to the second HD lane in the topology map.

It should be understood that the first HD lane and the second HD lane are adjacent lanes.

It should be understood that for all the two HD lanes in the HD lanes that are adjacent and parallel lanes, the nodes of the two HD lanes can be connected bidirectionally to obtain a final topology map.

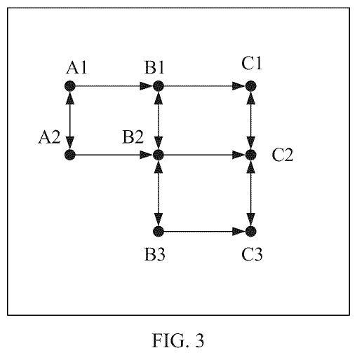

FIG. 3 is a topology map according to an embodiment of the present disclosure. As shown in FIG. 3, if two lanes corresponding to a node Al and a node A2 are adjacent and parallel lanes, the node A1 and the node A2 are connected bidirectionally. If two lanes corresponding to the node A1 and a node B1 are in an anterior-posterior connection relation, the node A1 and the node B1 are connected unidirectionally in a direction from the node A1 to the node B1. If two lanes corresponding to the node A1 and a node C1 are communicated unidirectionally, the node A1 and the node C1 are communicated unidirectionally. If lanes corresponding to the node B1 and a node B3 are non-adjacent but parallel lanes, the node B1 and the node B3 are communicated bidirectionally.

According to the implementation, for parallel lanes, edges are constructed for nodes corresponding to the lanes. As such, more feasible alternative routes can be obtained in the subsequent search for a route communicated from a start point node to an end point node. Furthermore, a final target route is screened from the plurality of alternative routes, or a target route is reorganized based on the plurality of alternative routes. The target route thus obtained is more suitable for navigation.

A process for determining the target route will be exemplarily introduced below.

In one implementation, the determining a target route in the topology map based on the start point and the end point of the trajectory includes: determining a first node corresponding to the HD lane where the start point of the trajectory is located and a second node corresponding to the HD lane where the end point of the trajectory is located in the topology map; searching in the topology map for a route communicated from the first node to the second node to obtain a plurality of alternative routes; obtaining a node set based on individual nodes in the individual alternative routes; and reorganizing the individual nodes in the node set based on a communication relation between the individual nodes in the node set in the topology map to obtain a target route.

It should be understood that a first node is a start point node of an alternate route and the target route, and a second node is an end point node of the alternate route and the target route.

It should be understood that each of the alternative routes can include a plurality of nodes, and any two of the plurality of nodes are communicated, at least unidirectionally communicated. Two or more of the plurality of nodes can be bidirectionally communicated.

It should be understood that the target route can be considered as a reconstructed or reorganized route. The target route can include a plurality of node groups consisting of one or more nodes, wherein a start point node group includes only the first node, and an end point node group includes only the second node. The node groups are unidirectionally communicated.

According to the implementation, any route communicated from the first node corresponding to a lane where the start point of the trajectory is located to the second node corresponding to a lane where the end point of the trajectory is located is searched by using the topology map. As such, more desirable alternative routes can be obtained. Furthermore, the node set is constructed by using the nodes in a plurality of alternative routes, such that the individual nodes are reorganized by utilizing a communication relation of the individual nodes in the node set in the topology map to obtain a final target route.

Certainly, in some embodiments, after the plurality of alternative routes are obtained, a route may be selected from the plurality of alternative routes as the target route.

In one implementation, the reorganizing individual nodes in the node set based on a communication relation between the individual nodes in the node set in the topology map to obtain a target route can include: grouping individual nodes in the node set based on a communication relation between the individual nodes in the node set in the topology map to obtain a plurality of node groups, wherein any two nodes in the node groups are bidirectionally communicated in the topology map, and any one node in the node groups and any one node in other node groups in the topology map are unidirectionally communicated; and unidirectionally connecting the plurality of node groups based on the anterior-posterior connection relation between the individual nodes in the individual node groups and individual nodes in other node groups in the topology map to obtain a target route.

It should be understood that for any ungrouped third node in the node set, all the nodes bidirectionally communicated with the third node are determined among the ungrouped nodes in the node set. In this way, it is determined that all the nodes are classified into a group with the third node. It should be noted that if there is no node bidirectionally communicated with the third node among the ungrouped nodes in the node set, the third node is classified into a group. In this way, the node set is grouped according to such an operation until all the nodes in the node set are grouped, such that a plurality of node groups can be obtained.

It should be understood that for the first node group of the plurality of node groups, the next node group of the first node group is determined among the plurality of node groups. A fourth node in the first node group and a fifth node in the next node group of the first node group are in an anterior-posterior connection relation in the topology map in a direction from the fourth node to the fifth node. Then, the first node group and the next node group of the first node group are connected unidirectionally, and the next node group of the first node group is used as a new first node group, the next node group of the first node group is continuously determined in the plurality of node groups, and the first node group and the next node group of the first node group are connected unidirectionally until the individual node groups in the node groups are connected. Thus, the final target route can be obtained.

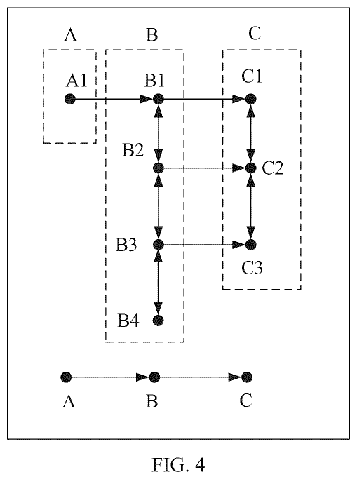

FIG. 4 is a schematic diagram of node groups and a target route according to an embodiment of the present disclosure.

As shown in FIG. 4, a node group A includes a node A1, a node group B includes nodes B1 to B4, and a node group C includes nodes C1 to C3. If the node B1 and the node C1 are in an anterior-posterior connection relation in the topology map, the node group A is connected with the node group B in a direction from the node group A to the node group B. If the node B1 and the node C1 are in an anterior-posterior connection relation in the topology map, the node B2 and the node C2 are in an anterior-posterior connection relation in the topology map, the node B3 and the node C3 are in an anterior-posterior connection relation in the topology map, and the node B4 and the node C3 are in an anterior-posterior connection relation in the topology map, the node group B is connected with the node group C in a direction from the node group B to the node group C. As such, the individual node groups are similarly connected to form a new route that can be used as the target route. For example, a target route from the node group A to the node group B and then to the node group C is formed as shown in FIG. 4. The individual nodes in the target route serve as one node group, and each of the nodes in the node group represents one lane.

Because the target route is a new route obtained by reorganizing the nodes and is not a route in the topology map, the target route can be called a virtual route.

According to the implementation, the individual nodes in the node set are grouped, and then the individual node groups are connected, such that various possible alternative routes can be virtualized into a target route, and more routes can be encompassed. As such, when the HD trajectory is matched, more HD trajectory information can be obtained, and the closest lane trajectory can be determined from the HD trajectory in a segment-wise manner during the navigation, which improves the driving flexibility and the user experience.

A process for matching individual HD trajectory segments will be exemplarily introduced below.

In one implementation, the matching respective HD trajectory segments in an HD map based on individual SD trajectory segments in the target SD trajectory includes: determining HD trajectory segments whose distances from the SD trajectory segments are within a preset distance range in the HD map to obtain at least one candidate HD trajectory segment; and determining HD trajectory segments corresponding to the SD trajectory segments based on the at least one candidate HD trajectory segment.

Exemplarily, a preset distance range can be within 50 meters or 100 meters without any restrictions herein, and can be set according to actual needs.

It should be understood that since trajectory points in the SD trajectory segments are location information in the SD map, the SD trajectory segments should be mapped into the HD map by using a spatial position relation between the SD map and the HD map, such that respective mapped trajectory segments are obtained. Then, with the mapped trajectory segments as a center and a set radius as a center of a circle, the HD trajectory segments located within the circle can be used as the candidate HD trajectory segments. The set radius can be within 50 meters or 100 meters.

Then, all or some of the HD trajectory segments are selected from the candidate HD trajectory segments described above as the HD trajectory segments corresponding to the SD trajectory segments.

According to the implementation, the HD trajectory segments matching with the SD trajectory segments can be obtained from the HD map by utilizing the distance.

In one implementation, the determining HD trajectory segments corresponding to the SD trajectory segments based on the at least one candidate HD trajectory segment includes: determining a reference direction based on a driving direction of the SD trajectory segments; and determining a candidate HD trajectory segment in which an angle between the driving direction and the reference direction is less than a preset angle threshold in the at least one candidate HD trajectory segment to obtain HD trajectory segments corresponding to the SD trajectory segments.

It should be understood that both the SD trajectory segments and the HD trajectory segments have directions. For example, if an angle between a driving direction of the SD trajectory segments and a driving direction of the candidate HD trajectory segments is greater than 90 degrees, it can be considered that the driving direction of the candidate HD trajectory segments is opposite to that of the SD trajectory segments, and in this case, the candidate HD trajectory segments are not regarded as the HD trajectory segments corresponding to the SD trajectory segments. For another example, if the angle between the driving direction of the SD trajectory segments and the driving direction of the candidate HD trajectory segments is less than 90 degrees, it can be considered that the driving direction of the candidate HD trajectory segments may be the same as that of the SD trajectory segments, and in this case, the candidate HD trajectory segments may be regarded as the HD trajectory segments corresponding to the SD trajectory segments.

It should be understood that the candidate HD trajectory segments corresponding to the SD trajectory segments may include a plurality of candidate HD trajectory segments.

According to the implementation, the candidate HD trajectory segments in the candidate HD trajectory segments that are opposite to the SD trajectory segments can be excluded, such that erroneous candidate HD trajectory segments can be filtered out. In this way, accurate HD trajectory segments corresponding to the SD trajectory segments are obtained.

Compared with the prior art, the embodiment of the present disclosure lowers the matching degree of the HD trajectory segment with the SD trajectory segments, so as to obtain more HD trajectory segments. Then, the individual nodes corresponding to the individual lanes are connected by utilizing relations between the individual lanes in the individual HD trajectory segments to obtain the topology map of the nodes. Then, with the start point and the end point of the HD trajectory, all the routes communicated from the start point to the end point are searched in the topology map of the nodes, the nodes in all the routes are reorganized, such that the target route is obtained. The corresponding HD trajectory is obtained by means of the target route from the HD map. The HD trajectory thus obtained is more matchable with the SD trajectory.

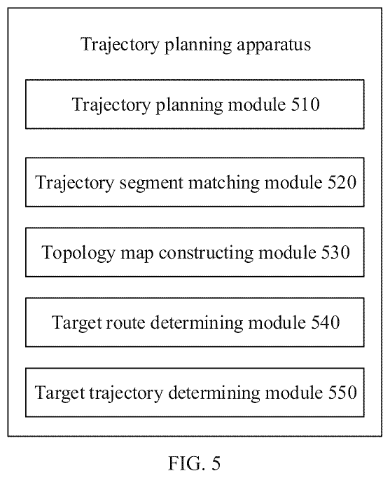

FIG. 5 is a block diagram showing a structure of a trajectory planning apparatus according to an embodiment of the present disclosure.

As shown in FIG. 5, the trajectory planning apparatus may include:

a trajectory planning module 510 configured to plan a target SD trajectory in an SD map based on a start point and an end point of a trajectory;

a trajectory segment matching module 520 configured to match respective HD trajectory segments in an HD map based on individual SD trajectory segments in the target SD trajectory;

a topology map constructing module 530 configured to connect nodes corresponding to individual HD lanes in the individual HD trajectory segments based on relations between the individual HD lanes in the individual HD trajectory segments to obtain a topology map;

a target route determining module 540 configured to determine a target route in the topology map based on the start point and the end point of the trajectory; and

a target trajectory determining module 550 configured to determine a corresponding target HD trajectory in the HD map based on the target route.

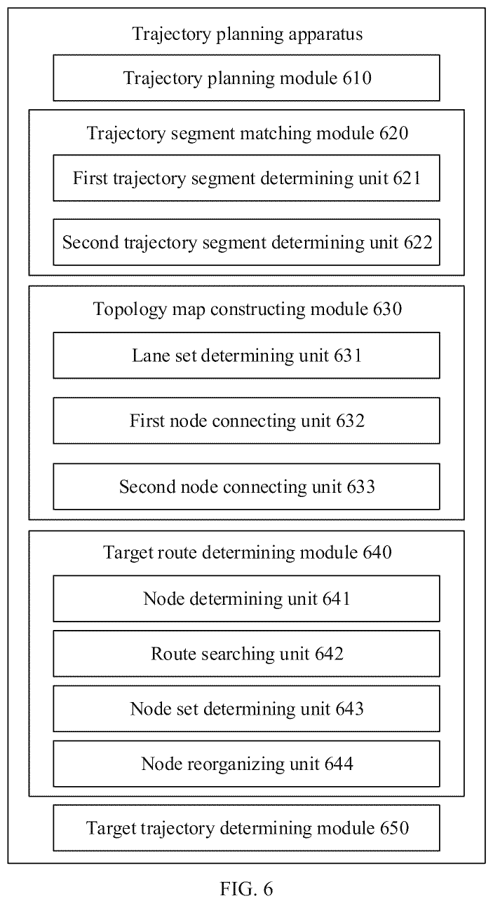

FIG. 6 is a block diagram showing a structure of a trajectory planning apparatus according to another embodiment of the present disclosure. Functions or structures of a trajectory planning module 610, a trajectory segment matching module 620, a topology map constructing module 630, a target route determining module 640 and a target trajectory determining module 650 in FIG. 6 are to the same as those of the trajectory planning module 510, the trajectory segment matching module 520, the topology map constructing module 530, the target route determining module 540 and the target trajectory determining module 550 in FIG. 5 respectively, and are not described in detail herein.

In one implementation, the topology map constructing module 630 includes:
a lane set determining unit 631 configured to determine an HD lane set based on individual HD lanes in the individual HD trajectory segments, and
a first node connecting unit 632 configured to unidirectionally connect individual nodes corresponding to individual lanes in the HD lane set based on an anterior-posterior connection relation between the individual HD lanes in the HD lane set to obtain the topology map.

In one implementation, the apparatus may further include:
a second node connecting unit 633 configured to, if a first HD lane and a second HD lane in the HD lane set are parallel lanes, bidirectionally connect a node corresponding to the first HD lane and a node corresponding to the second HD lane in the topology map.

In one implementation, the target route determining module 640 includes:
a node determining unit 641 configured to determine a first node corresponding to the HD lane where the start point of the trajectory is located and a second node corresponding to the HD lane where the end point of the trajectory is located in the topology map,
a route searching unit 642 configured to search in the topology map for a route communicated from the first node to the second node to obtain a plurality of alternative routes,

a node set determining unit 643 configured to obtain a node set based on individual nodes in the individual alternative routes, and
a node recognizing unit 644 configured to reorganize the individual nodes in the node set based on a communication relation between the individual nodes in the node set in the topology map to obtain a target route.

In one implementation, the node recognizing unit 644 is particularly configured to:
group the individual nodes in the node set based on the communication relation between the individual nodes in the node set in the topology map to obtain a plurality of node groups, wherein any two nodes in the node group are bidirectionally communicated in the topology map, and the individual nodes in the node group and individual nodes in other node groups are unidirectionally communicated in the topology map; and
unidirectionally connect the plurality of node groups based on the anterior-posterior connection relation between the individual nodes in the individual node groups and the individual nodes in other node groups in the topology map to obtain a target route.

In one implementation, the trajectory segment matching module 620 includes:
a first trajectory segment determining unit 621 configured to determine HD trajectory segments whose distances from the SD trajectory segments are within a preset distance range in the HD map to obtain at least one candidate HD trajectory segment, and
a second trajectory segment determining unit 622 configured to determine HD trajectory segments corresponding to the SD trajectory segments based on the at least one candidate HD trajectory segment.

In an embodiment, the second trajectory segment determining unit 622 is particularly configured to determine a reference direction based on a driving direction of the SD trajectory segments, and determine a candidate HD trajectory segment in which an angle between the driving direction and the reference direction is less than a preset angle threshold in the at least one candidate HD trajectory segment to obtain HD trajectory segments corresponding to the SD trajectory segments.

The description of specific functions and examples of the modules and sub-modules of the apparatus of the embodiments of the present disclosure can be found in the relevant descriptions of the corresponding steps in the method of the embodiments, and will be omitted here.

In the technical solution provided in the present disclosure, the acquisition, storage and application of personal information of users involved are in accordance with relevant laws and regulations and do not violate public order and morals.

According to an embodiment of the present disclosure, the present disclosure further provides an electronic device, a readable storage medium and a computer program product.

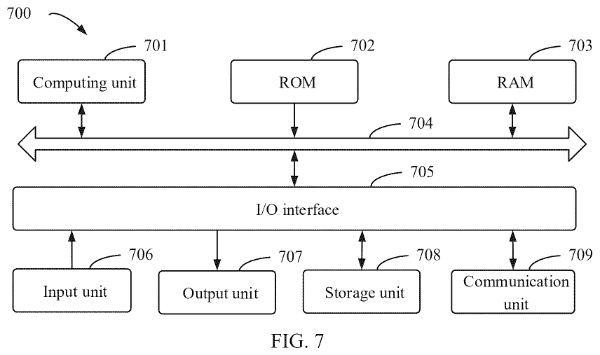

FIG. 7 shows a schematic block diagram showing an example electronic device 700 which can be used to implement an embodiment of the present disclosure. The electronic device is designed to represent various forms of digital computers, such as laptop computers, desktop computers, workbenches, personal digital assistants, servers, blade servers, mainframe computers and other suitable computers. The electronic device can further represent various forms of mobile devices, such as personal digital assistants, cellular phones, smartphones, wearable devices and other similar computing apparatuses. Components shown herein, their connections and relations, and their functions are only examples and are not intended to limit an implementation of the present disclosure described and/or required herein.

As shown in FIG. 7, a device 700 includes a computing unit 701 which can perform various appropriate actions and processes according to computer programs stored in a read-only memory (ROM) 702 or loaded from a storage unit 708 into a random access memory (RAM) 703. Various programs and data required for the operation of the device 700 can be stored in the RAM 703. The computing unit 701, the ROM 702 and the RAM 703 are connected to each other via a bus 704. An input/output (I/O) interface 705 is also connected to the bus 704.

A plurality of components in the device 700 are connected to the I/O interface 705, including an input unit 706 such as a keyboard and a mouse, an output unit 707 such as various types of displays and speakers, a storage unit 708 such as a disk and a CD, and a communication unit 709 such as a network card, a modem and a wireless communication transceiver. The communication unit 709 allows the device 700 to exchange information/data with other devices through computer networks such as the Internet and/or various telecommunications networks.

A computing unit 701 can be various general-purpose and/or special-purpose processing components with processing and computing capabilities. Some examples of the computing unit 701 include but are not limited to central processing units (CPUs), graphics processing units (GPUs), various special-purpose artificial intelligence (AI) computing chips, various computing units running machine learning model algorithms, digital signal processors (DSPs), and any suitable processors, controllers, microcontrollers, and the like. The computing unit 701 executes various methods and processes described above, such as a trajectory planning method. For example, in some embodiments, the trajectory planning method may be implemented as a computer software program tangibly contained in a machine-readable medium, such as a storage unit 708. In some embodiments, some or all of the computer programs may be loaded and/or installed onto the device 700 via the ROM 702 and/or the communication unit 709. When the computer programs are loaded into the RAM 703 and executed by the computing unit 701, one or more steps of the trajectory planning method described above can be performed. Alternatively, in other embodiments, the computing unit 701 may be configured to perform the trajectory planning method through any other suitable means (e.g., by means of firmware).

Various implementations of the system and the technology described above in the present disclosure can be implemented in a digital electronic circuit system, an integrated circuit system, a field programmable gate array (FPGA), an application specific integrated circuit (ASIC), an application specific standard product (ASSP), a system on chip (SOC) system, a complex programmable logic device (CPLD), computer hardware, firmware, software, and/or a combination thereof. These various implementations may include: implementation in one or more computer programs, the one or more computer programs are executable and/or interpretable on a programmable system including at least one programmable processor which may be a special-purpose or general-purpose programmable processor and can receive data and instructions from a storage system, at least one input apparatus and at least one output apparatus and transmit the data and the instructions to the storage system, the at least one input apparatus and the at least one output apparatus.

A program code for implementing the method of the present disclosure can be written in any combination of one or more programming languages. These program codes can be provided to a processor or a controller of a general-purpose computer, a special-purpose computer, or other programmable data processing apparatuses, such that the program code, when executed by the processor or the controller, implements functions/operations specified in the flowchart and/or the block diagram. The program code can be executed entirely on a machine, partially on a machine, partially on a machine as a standalone software package and partially on a remote machine, or entirely on a remote machine or a server.

In the context of the present disclosure, a machine-readable medium may be a tangible medium containing or storing a program for use by or in combination with an instruction execution system, apparatus or device. The machine-readable medium can be a machine-readable signal medium or machine-readable storage medium. The machine-readable medium may include, but is not limited to, an electronic, magnetic, optical, electromagnetic, infrared, or semiconductor system, apparatus and device, or any suitable combination of the above. More specific examples of the machine-readable storage medium include an electrical connection based on one or more wires, a portable computer disk, a hard drive, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination of the above.

In order to provide the interaction with the user, the system and the technology described herein can be implemented in a computer equipped with a display apparatus (for example, a CRT (cathode ray tube) or LCD (liquid crystal display) monitor) for displaying information to a user; and a keyboard and a pointing apparatus (for example, a mouse or a track ball), through which the user can provide an input to the computer. Other types of apparatuses can be used to provide the interaction with the user. For example, feedback provided to the user can be any form of sensory feedback (for example, visual feedback, auditory feedback or tactile feedback), and can receive the input from the user in any form (including sound input, speech input or tactile input).

The system and the technology described herein can be implemented in a computing system including a backend component (for example, as a data server), or a computing system including a middleware component (for example, an application server), or a computing system including a frontend component (for example, a user computer with a graphical user interface or a web browser, through which the user can interact with the implementation of the system and the technology described herein), or a computing system including any combination of the backend component, the middleware component or the frontend component. The components of the system can be interconnected through any form or medium of digital data communication (for example, a communication network). Examples of the communication network include a local area network (LAN), a wide area network (WAN) and the Internet.

The computer system can include a client and a server. The client and the server are generally far apart from each other and typically interact through the communication network. A client-server relation is generated by computer programs running on corresponding computers and having the client-server relation with each other. The server can be a cloud server, or a server of a distributed system, or a server combining a blockchain.

It should be understood that steps can be reordered, added or deleted by using various forms of processes shown above. For example, the steps described in the present disclosure can be performed in parallel, or sequentially or in different orders provided that desired results of the technical solution disclosed in the present disclosure can be achieved, and are not limited herein.

The detailed description does not constitute a limitation on the scope of protection of the present disclosure. It should be understood by those skilled in the art that various modifications, combinations, sub-combinations and substitutions can be made based on design requirements and other factors. Any modifications, equivalent substitutions and improvements made within the principles of the present disclosure shall be included within the scope of protection of the present disclosure.

What is claimed is:

1. A trajectory planning method, comprising:
planning a target standard definition (SD) trajectory in an SD map based on a start point and an end point of a trajectory;
matching respective high definition (HD) trajectory segments in an HD map based on individual SD trajectory segments in the target SD trajectory;
connecting nodes corresponding to individual HD lanes in the individual HD trajectory segments based on relations between the individual HD lanes in the individual HD trajectory segments to obtain a topology map;
determining a target route in the topology map based on the start point and the end point of the trajectory; and
determining a corresponding target HD trajectory in the HD map based on the target route.

2. The method of claim 1, wherein the connecting the nodes corresponding to the individual HD lanes in the individual HD trajectory segments comprises:
determining an HD lane set based on the individual HD lanes in the individual HD trajectory segments; and
unidirectionally connecting individual nodes corresponding to the individual HD lanes in the HD lane set based on an anterior-posterior connection relation between the individual HD lanes in the HD lane set to obtain the topology map.

3. The method of claim 2, further comprising:
after determining that a first HD lane and a second HD lane in the HD lane set are parallel lanes, bidirectionally connecting a node corresponding to the first HD lane and a node corresponding to the second HD lane in the topology map.

4. The method of claim 3, wherein the determining the target route in the topology map based on the start point and the end point of the trajectory comprises:
determining a first node corresponding to the HD lane where the start point of the trajectory is located and a second node corresponding to the HD lane where the end point of the trajectory is located in the topology map;
searching in the topology map for a route communicated from the first node to the second node to obtain a plurality of alternative routes;
obtaining a node set based on individual nodes in individual alternative routes; and
reorganizing the individual nodes in the node set based on a communication relation between the individual nodes in the node set in the topology map to obtain the target route.

5. The method of claim 4, wherein the reorganizing the individual nodes in the node set comprises:
grouping the individual nodes in the node set based on the communication relation between the individual nodes in the node set in the topology map to obtain a plurality of node groups, wherein any two nodes in the node groups are bidirectionally communicated in the topology map, and the individual nodes in the node groups are unidirectionally communicated with individual nodes in other node groups in the topology map; and
unidirectionally connecting the plurality of node groups based on the anterior-posterior connection relation between the individual nodes in the individual node groups and the individual nodes in the other node groups in the topology map to obtain the target route.

6. The method of claim 1, wherein the matching the respective HD trajectory segments in the high definition HD map based on the individual SD trajectory segments in the target SD trajectory comprises:
determining HD trajectory segments whose distances from the SD trajectory segments are within a preset distance range in the HD map to obtain at least one candidate HD trajectory segment; and
determining HD trajectory segments corresponding to the SD trajectory segments based on the at least one candidate HD trajectory segment.

7. The method of claim 6, wherein the determining the HD trajectory segments corresponding to the SD trajectory segments based on the at least one candidate HD trajectory segment comprises:
determining a reference direction based on a driving direction of the SD trajectory segments; and
determining a candidate HD trajectory segment in which an angle between the driving direction and the reference direction is less than a preset angle threshold in the at least one candidate HD trajectory segment to obtain HD trajectory segments corresponding to the SD trajectory segments.

8. An electronic device, comprising:
at least one processor; and
a memory connected in communication with the at least one processor;
wherein the memory stores an instruction executable by the at least one processor, and the instruction, when executed by the at least one processor, enables the at least one processor to perform:
planning a target standard definition (SD) trajectory in an SD map based on a start point and an end point of a trajectory;
matching respective high definition (HD) trajectory segments in an HD map based on individual SD trajectory segments in the target SD trajectory;
connecting nodes corresponding to individual HD lanes in the individual HD trajectory segments based on relations between the individual HD lanes in the individual HD trajectory segments to obtain a topology map;
determining a target route in the topology map based on the start point and the end point of the trajectory; and
determining a corresponding target HD trajectory in the HD map based on the target route.

9. The electronic device of claim 8, wherein the instruction, when executed by the at least one processor, enables the at least one processor to performing connecting the nodes corresponding to the individual HD lanes in the individual HD trajectory segments by:
determining an HD lane set based on the individual HD lanes in the individual HD trajectory segments; and
unidirectionally connecting individual nodes corresponding to the individual HD lanes in the HD lane set based on an anterior-posterior connection relation between the individual HD lanes in the HD lane set to obtain the topology map.

10. The electronic device of claim 9, wherein the instruction, when executed by the at least one processor, enables the at least one processor to further perform:
after determining that a first HD lane and a second HD lane in the HD lane set are parallel lanes, bidirectionally connecting a node corresponding to the first HD lane and a node corresponding to the second HD lane in the topology map.

11. The electronic device of claim 10, wherein the instruction, when executed by the at least one processor, enables the at least one processor to perform determining the target route in the topology map by:
determining a first node corresponding to the HD lane where the start point of the trajectory is located and a second node corresponding to the HD lane where the end point of the trajectory is located in the topology map;
searching in the topology map for a route communicated from the first node to the second node to obtain a plurality of alternative routes;
obtaining a node set based on individual nodes in individual alternative routes; and
reorganizing the individual nodes in the node set based on a communication relation between the individual nodes in the node set in the topology map to obtain the target route.

12. The electronic device of claim 11, wherein the instruction, when executed by the at least one processor, enables the at least one processor to perform reorganizing the individual nodes in the node set by:
grouping the individual nodes in the node set based on the communication relation between the individual nodes in the node set in the topology map to obtain a plurality of node groups, wherein any two nodes in the node groups are bidirectionally communicated in the topology map, and the individual nodes in the node groups are unidirectionally communicated with individual nodes in other node groups in the topology map; and
unidirectionally connecting the plurality of node groups based on the anterior-posterior connection relation between the individual nodes in the individual node groups and the individual nodes in the other node groups in the topology map to obtain the target route.

13. The electronic device of claim 8, wherein the instruction, when executed by the at least one processor, enables the at least one processor to perform matching the respective HD trajectory segments in the high definition HD map by:
determining HD trajectory segments whose distances from the SD trajectory segments are within a preset distance range in the HD map to obtain at least one candidate HD trajectory segment; and
determining HD trajectory segments corresponding to the SD trajectory segments based on the at least one candidate HD trajectory segment.

14. The electronic device of claim 13, wherein the instruction, when executed by the at least one processor, enables the at least one processor to perform determining the HD trajectory segments corresponding to the SD trajectory segments by:
determining a reference direction based on a driving direction of the SD trajectory segments; and
determining a candidate HD trajectory segment in which an angle between the driving direction and the reference direction is less than a preset angle threshold in the at least one candidate HD trajectory segment to obtain HD trajectory segments corresponding to the SD trajectory segments.

15. A non-transitory computer-readable storage medium storing a computer instruction thereon, wherein the computer instruction is used to cause a computer to perform:
planning a target standard definition (SD) trajectory in an SD map based on a start point and an end point of a trajectory;
matching respective high definition (HD) trajectory segments in an HD map based on individual SD trajectory segments in the target SD trajectory;
connecting nodes corresponding to individual HD lanes in the individual HD trajectory segments based on relations between the individual HD lanes in the individual HD trajectory segments to obtain a topology map;
determining a target route in the topology map based on the start point and the end point of the trajectory; and
determining a corresponding target HD trajectory in the HD map based on the target route.

16. The non-transitory computer-readable storage medium of claim 15, wherein the computer instruction is used to cause the computer to perform connecting the nodes corresponding to the individual HD lanes in the individual HD trajectory segments by:
determining an HD lane set based on the individual HD lanes in the individual HD trajectory segments; and
unidirectionally connecting individual nodes corresponding to the individual HD lanes in the HD lane set based on an anterior-posterior connection relation between the individual HD lanes in the HD lane set to obtain the topology map.

17. The non-transitory computer-readable storage medium of claim 16, wherein the computer instruction is used to cause the computer to further perform:
after determining that a first HD lane and a second HD lane in the HD lane set are parallel lanes, bidirectionally connecting a node corresponding to the first HD lane and a node corresponding to the second HD lane in the topology map.

18. The non-transitory computer-readable storage medium of claim 17, wherein the computer instruction is used to cause the computer to perform determining the target route in the topology map by:
determining a first node corresponding to the HD lane where the start point of the trajectory is located and a second node corresponding to the HD lane where the end point of the trajectory is located in the topology map;
searching in the topology map for a route communicated from the first node to the second node to obtain a plurality of alternative routes;
obtaining a node set based on individual nodes in individual alternative routes; and
reorganizing the individual nodes in the node set based on a communication relation between the individual nodes in the node set in the topology map to obtain the target route.

19. The non-transitory computer-readable storage medium of claim 18, wherein the computer instruction is used to cause the computer to perform reorganizing the individual nodes in the node set by:
grouping the individual nodes in the node set based on the communication relation between the individual nodes in the node set in the topology map to obtain a plurality of node groups, wherein any two nodes in the node groups are bidirectionally communicated in the topology map, and the individual nodes in the node groups are unidirectionally communicated with individual nodes in other node groups in the topology map; and
unidirectionally connecting the plurality of node groups based on the anterior-posterior connection relation between the individual nodes in the individual node groups and the individual nodes in the other node groups in the topology map to obtain the target route.

20. The non-transitory computer-readable storage medium of claim 15, wherein the computer instruction is used to cause the computer to perform matching the respective HD trajectory segments in the high definition HD map by:
determining HD trajectory segments whose distances from the SD trajectory segments are within a preset distance range in the HD map to obtain at least one candidate HD trajectory segment; and
determining HD trajectory segments corresponding to the SD trajectory segments based on the at least one candidate HD trajectory segment;
wherein the computer instruction is used to cause the computer to perform determining the HD trajectory segments corresponding to the SD trajectory segments by:
determining a reference direction based on a driving direction of the SD trajectory segments; and
determining a candidate HD trajectory segment in which an angle between the driving direction and the reference direction is less than a preset angle threshold in the at least one candidate HD trajectory segment to obtain HD trajectory segments corresponding to the SD trajectory segments.
